(19) United States
(12) Patent Application Publication
(10) Pub. No.: US 2021/0387379 A1
(43) Pub. Date: Dec. 16, 2021

(54) AUTOMATED GEMSTONE DETACHMENT

(71) Applicant: Sahajanand Technologies Private Limited, Gujarat (IN)

(72) Inventors: Chirag Oza, Nagalpur Gujarat Mehsana (IN); Munjal Gajjar, Adajan Patia Gujarat Surat (IN); Rahul Gaywala, Gujarat Surat (IN)

(21) Appl. No.: 17/290,855

(22) PCT Filed: Nov. 5, 2019
(86) PCT No.: PCT/IN2019/050819

§ 371 Date: May 3, 2021

(30) Foreign Application Priority Data
Nov. 5, 2018 (IN) 201821041901

(51) Int. Cl. B28D 5/00

(52) U.S. Cl. CPC B28D 5/0082

(57) ABSTRACT

A gemstone detachment assembly includes a rotatable member which can temporarily attach thereto a gemstone holder detachably holding a rough gemstone exhibit a motion with the rotatable member for a partial path of rotation of the rotatable member. A detachment tool can be positioned in a path of the moving rough gemstone and can detach the rough gemstone from the gemstone holder. A magnet positioned in proximity of the rotatable member can temporarily hold holder onto the rotatable member. The magnet can generate a magnetic field which can hold the holder when in a first portion of the path of rotation of the rotatable member and can release the holder in a second portion of the path of rotation of the rotatable member.

### TECHNICAL FIELD

The present subject matter relates, in general, to gemstone processing and, particularly but not exclusively, to automated gemstone detachment.

### BACKGROUND

Gemstones are naturally occurring deposits of minerals and can include, for example, diamonds, quartz, opals, sapphires, rubies, emeralds, and topaz. Since the gemstones are rare, they are highly valued for use. The value of these gemstones results from their color, luster, and the manner in which they transmit, refract, or reflect rays of light. For the enhancement of such properties, rough gemstones are analyzed and processed, by various techniques, such as planning by way of pre-processing and cutting, faceting, shaping, and polishing.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 schematically illustrates a gemstone detachment assembly, in accordance with an embodiment of the present subject matter

FIGS. 2(a)-2(d) illustrate automated detachment of the gemstone by the gemstone detachment assembly, in accordance with another embodiment of the present subject matter

FIG. 3 illustrates the process of the detachment of the rough gemstone from the gemstone holder, in accordance with the present subject matter.

### DETAILED DESCRIPTION

The present subject matter relates to aspects relating to automatic detachment of gemstones in a gemstone processing machine.

Rough gemstones have irregular dimensions, and undergo diverse processing steps, such as planning, estimating, measuring physical attributes, sawing, bruiting, and polishing to reach to finished state.

In an embodiment, the processing steps may be performed on multiple machines, such as gemstone planner machine, gemstone cutting machine, and the like. The step of planning of gemstone is performed in a gemstone planner machine. The gemstone planner machine scans the rough gemstone to measure basic geometry thereof. For example, shape, dimensions (length, width, and height). Thereafter, the gemstone planner machine estimates physical attributes of the gemstone based upon the geometry of the gemstone. The physical attributes along with the rough gemstone may be transferred further to the gemstone cutting machine for further cutting process.

In other embodiments, the processing steps may be performed on an integrated machine wherein different parts of the integrated machine perform the various processing steps. Accordingly, the step of planning of gemstone followed by one or more subsequent prSSocessing step may be performed within the integrated machine without having to transfer the gemstone from one machine to another.

In an example, for performing various steps of processing, the rough gemstone needs to be transferred from one machine to another. In an alternate example, the rough gemstone may be transferred from one stage to another in an integrated machine. However, transfer of the rough gemstone in either scenario, is carried out by attachment of the rough gemstone with a holder for ease of handling and to avoid damage to the gemstone. Some steps of the processing require the rough gemstone to be separated from the holder for better processing of the rough gemstone. For example, after measurement of physical attributes of the rough gemstone in the integrated gemstone planner machine, the gemstone is separated from a holder, and the rough gemstone detached from the holder is fed as an input to the gemstone cutting machine for further processing.

In state of the art, the step of detachment of the rough gemstone from the holder is carried out manually by an operator. Thus, the conventional gemstone detachment technique is dependent on human intervention and requires skilled operator to perform the detachment. The manual detachment of the gemstone may lead to damage in the gemstone due to human error. Additionally, the manual detachment may be time consuming.

To this end, machine for automated detachment of gemstone affixed to a holder in an integrated machine or between multiple machines that perform the various processing steps relating to gemstone processing, are described herein. The automated apparatus and method for automatic detachment of gemstones, overcomes the above-described problems associated with manual detachment technique and ensure that gemstones are detached without any damage or delay.

Various embodiments of the apparatus and method for automatic detachment of rough gemstones from their respective holder. The described embodiments are provided as non-limiting examples of the apparatus and method for automatic detachment of gemstones.

In an embodiment, after planning of the rough gemstones affixed to their respective holders, the rough gemstones with their respective holders are transferred to automatic gemstone detachment machine. The automatic gemstone detachment machine, separated the rough gemstones from their respective holders by an automated and controlled mechanism. Since, the detachment by the automatic gemstone detachment machine, lacks human intervention, the detachment mechanism is accurate and eliminates human errors.

In another embodiment, the automatic gemstone detachment machine includes a rotatable member with a cavity to mount a rough gemstone affixed to a holder. The rough gemstone affixed to the holder is mounted in the rotatable member, and the rotatable member is rotated by pre-defined degrees. In an example, the pre-defined degrees may be 90 degrees. In another example, the pre-defined degrees may be 180 degrees. The pre-defined degrees bring the rough gemstone affixed to the holder in contact with a detachment tool. The detachment tool separates the rough gemstone and the holder.

In an example, after separation of the rough gemstone from the holder, the gemstone may securely pass through a gemstone collecting bin for further processing.

In another example, after separation of the holder from the rough gemstone, the holder may still be mounted in the cavity of the rotatable member. Therefore, the rotatable member may rotate by a pre-defined angle, such that the cavity is aligned with holder bin. After the alignment, the holder in the cavity may dismount and may pass through the holder bin for collection.

Thus, the present subject matter relates to techniques of detachment of rough gemstones from their respective holders using an automated detachment mechanism. The automatic detachment machine is controlled by a computing device, uses low-cost hardware equipment, and has limited or no manual intervention. Therefore, the gemstone detachment achieved in accordance with the techniques of the present subject matter provides accurate and damage free detachment of the rough gemstones and involves substantially low cost in generating the finished gemstone. In other words, the gemstone detachment executed in accordance with the present subject matter achieves increase in accuracy of detachment of the rough gemstone and reduction cost associated with the equipment used for the detachment of the rough gemstone.

These and other advantages of the present subject matter would be described in greater detail in conjunction with the following figures. While aspects of gemstone detachment can be implemented in any number of different configurations, the embodiments are described in the context of the following device(s) and method(s).

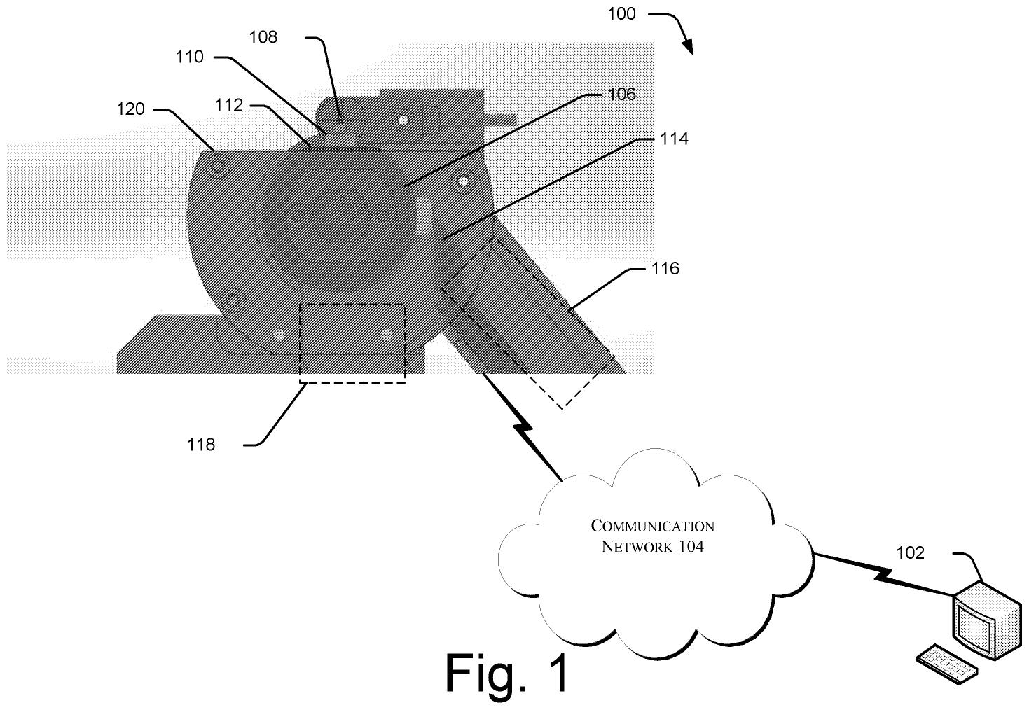

FIG. 1 illustrate schematics of a gemstone detachment assembly 100 for separating rough gemstones affixed to their respective gemstone holder, communicatively coupled to a computing device 102 over communication network 104, in accordance with an embodiment of the present subject matter.

In accordance with an embodiment of the present subject matter, the gemstone detachment assembly 100 includes a rotatable member 106. In an example, the rotatable member 106 may be operated by a motor, say a motor, a stepper motor, or an assembly including a motor and a gear box for actuating the rotatable member 106. In another example, the motor may be controlled by the computing device 102.

In an embodiment, the rotatable member 106 may include a platform 112 for mounting of the rough gemstone 108. Further, the rotatable member 106 may also include a cavity (not shown) for mounting a gemstone holder 110 on which a rough gemstone 108 is affixed. In an example, the cavity may be formed on a platform 112 of the rotatable member 106. In another example, dimension of the cavity may be formed to accommodate single gemstone holder at a time. Thus, detachment of rough gemstone from a gemstone holder may be performed for a single rough gemstone at a time using the gemstone detachment assembly 100.

In an implementation, the gemstone detachment assembly 100 may further include a detachment tool 114. In an example, the detachment tool 114 may have a sharp profile so as to facilitate seamless detachment of the rough gemstone 108 from the gemstone holder 110. Further, the detachment tool 114 may be coupled to a gemstone collecting bin 116. In an example, the gemstone collecting bin 116 may be an inclined passage facilitating transfer of the rough gemstone 108 detached from the gemstone holder 110 for post-planning processing steps. In one example, the detachment tool 114 may have a guiding profile such that guiding profile may guide the detached gemstone into the gemstone collecting bin 116.

In an example, the gemstone detachment assembly 100 also includes a gemstone holder bin 118. In an example, the gemstone holder bin 118 may facilitate transfer of the gemstone holder 110 after detachment from the rough gemstone 108, to a collection unit. In another example, positioning of the gemstone collecting bin 116 and the gemstone holder bin 118 in the gemstone detachment assembly 100 may be separated by pre-defined angle.

In an implementation, the rough gemstone 108 affixed to the gemstone holder 110 may be mounted in the cavity of the rotatable member 106, when the rotatable member 106 is aligned at a pre-defined alignment. In an example, the pre-defined location is indicative of a location when the platform 112 is aligned parallel to flat surface 120 of the gemstone detachment assembly 100. After mounting of the gemstone holder 110 the computing device 102 may communicate with the motor to actuate the rotatable member 106 by a pre-defined degree, amounting to alignment of the cavity perpendicular to the detachment tool 114. As a result of the alignment, the rough gemstone 108 affixed to the gemstone holder 110 may come in contact with the detachment tool 114, and the detachment tool 114 may separate the rough gemstone 108 from the gemstone holder 110.

In an example, after the detachment of the rough gemstone 108, the rough gemstone 108 may fall in the gemstone collecting bin 116. The gemstone collecting bin 116 may transfer the rough gemstone 108 for post-planning processing. In another example, the computing device 102 may again communicate with the motor to actuate the rotatable member 106 by another pre-defined angle, amounting to alignment of the cavity along the gemstone holder bin 118. Upon, the alignment of the cavity along the gemstone holder bin 118, the gemstone holder 110 in the cavity may dismount under impact of an external force and may fall in the gemstone holder bin 118. In an example, the external force may be gravitational force. Further, the gemstone holder bin 118 may transfer the gemstone holder 110 towards a collection unit. Thus, the rough gemstone 108 is detached from the gemstone holder 110 without human intervention by way of the gemstone detachment assembly 100 controlled by the computing device 102.

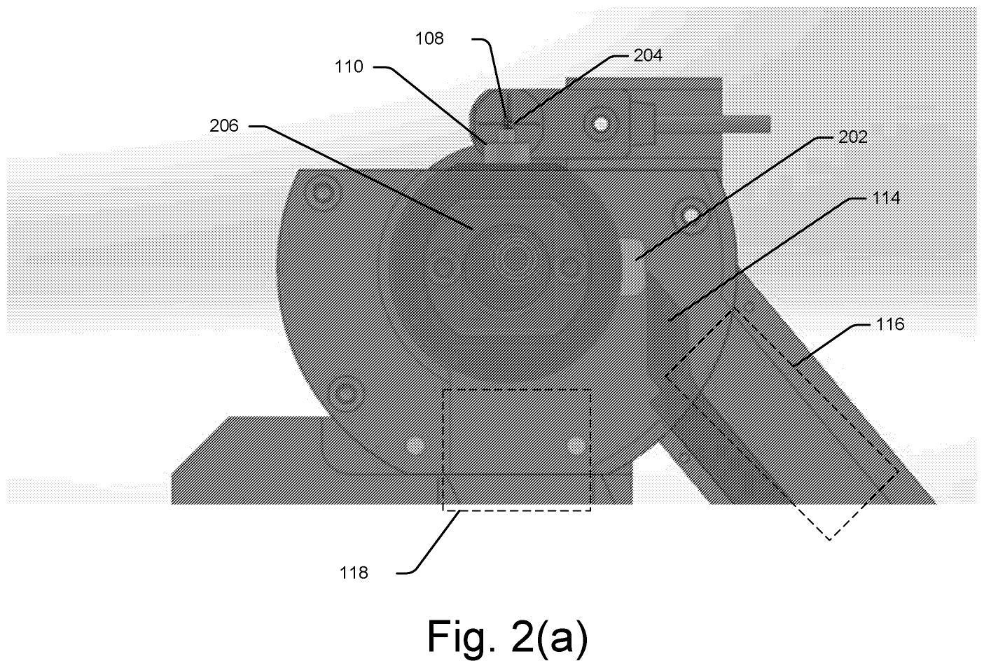

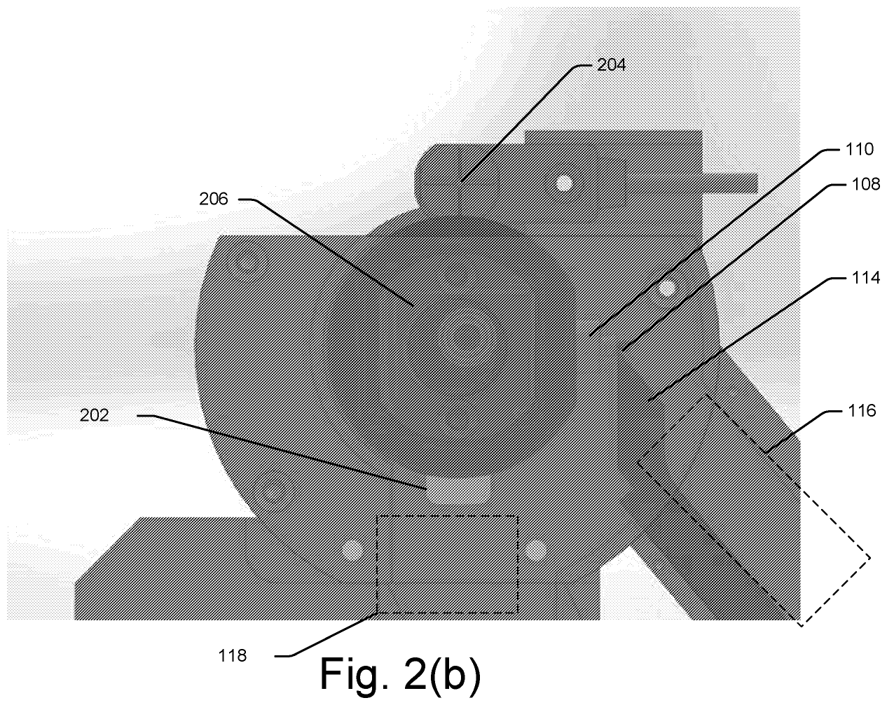

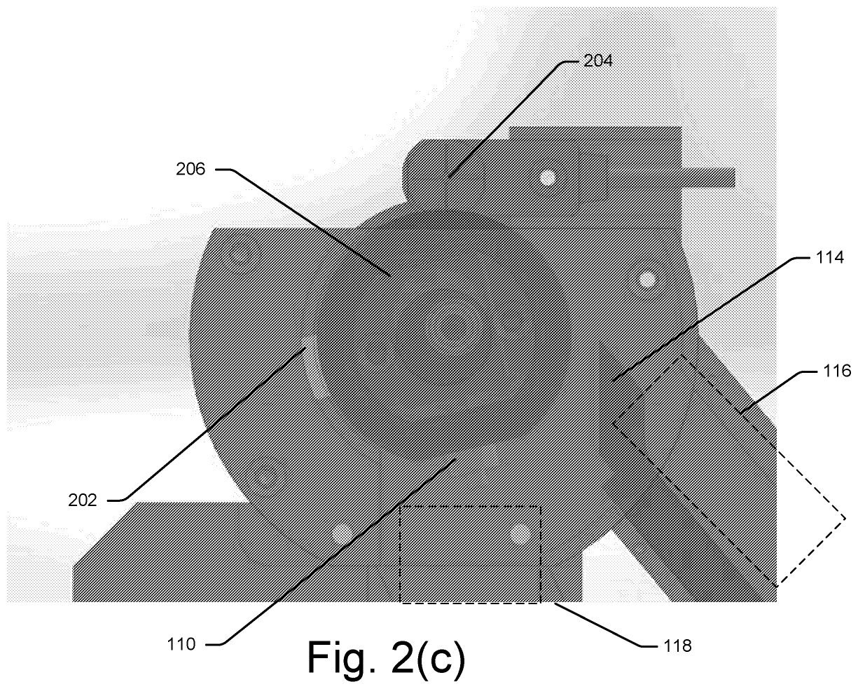

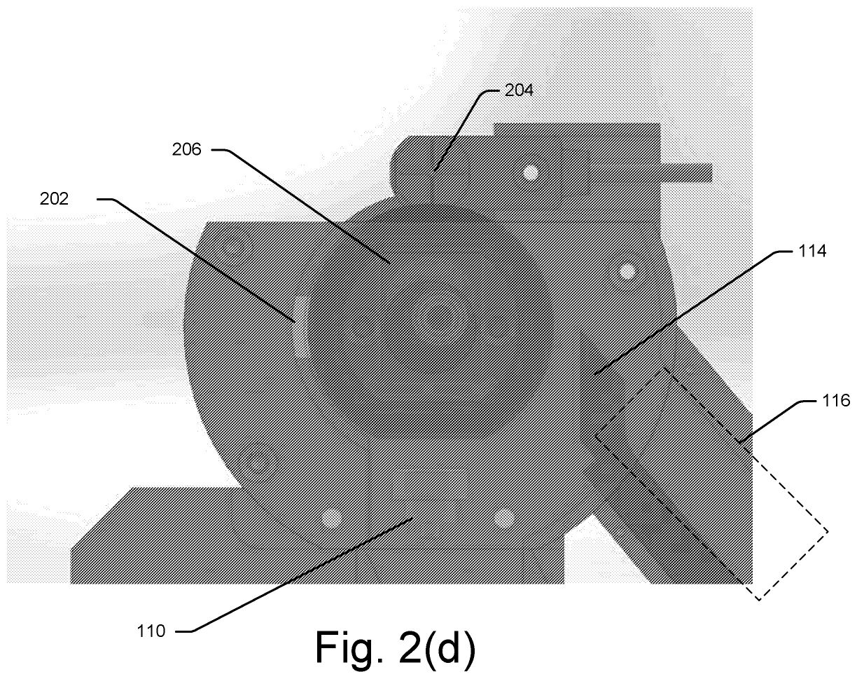

FIGS. 2(a)-2(d) illustrate the automated detachment of gemstones affixed to gemstone holder 110 by the gemstone detachment assembly 100, in accordance with an embodiment of the present subject matter.

As illustrated in FIG. 2(a), the gemstone detachment assembly 100 includes a reference marker 202 assembled on the rotatable member 106, such that the reference marker 202 may rotate along the axis of rotation of the rotatable member 106 when the rotatable member 106 actuates. In an example, the reference marker 202 may be assembled at a calibrated distance from the cavity on circumference of the rotatable member 106.

Further, the gemstone detachment assembly 100 may also include a sensor 204. In an example, the sensor 204 may be a proximity sensor, laser sensor or the like. The sensor 204 may be configured to determine a homing position for the rotatable member 106 based on the position of the reference marker 202. The sensor 204 may be fixed along a home position A of the rotatable member 106. In an example, the sensor 204 may be controlled by the computing device 102. In an example, the computing device may calculate the distance covered by the gemstone holder 110 in the path of rotation of the rotatable member 106 using data generated by the sensor 204.

In an implementation, the gemstone detachment assembly 100 may include an magnet 206. The magnet 206 may have a hole at centre. In an example, the gemstone holder 110 may be made up of magnetic material and the magnet may protect the gemstone holder 110 from dismounting from the cavity as a result of vibrations or the actuation of the rotatable member 106 or both. In another example, the magnet 206 may be located in centre of the rotatable member 106, such that the distance between centre of the rotatable member 106 and the centre of the circular hole is offset. Further, the magnet 206 may be formed in a shape such that the magnetic field of the magnet 206 holds the gemstone holder 110 onto the platform 112. In an example, in a first portion of the path of rotation of the rotatable member 106, the force generated by the magnetic field of the magnet 206 is stronger than an external force, e.g. gravitational force, required to unmount the gemstone holder 110. In another example, in a second portion of the path of rotation of the rotatable member 106, the force generated by the magnetic field of the magnet 206 is weaker than an external force required to unmount the gemstone holder 110. In other words, the magnet 206 is capable of generating a magnetic field to hold the gemstone holder 110 when in a first portion of the path of rotation of the rotatable member 106 and release the gemstone holder 110 in a second portion of the path of rotation of the rotatable member 106.

In an embodiment, the motor receives a signal from the computing device 102 to start rotation of the rotatable member 106. Upon the rotation when the reference marker 202 aligns along the sensor 204, the sensor 204 may communicate alignment of the reference marker 202 to the computing device 102. The computing device 102 may communicate with the motor to halt actuation of the rotatable member 106. Upon the halting of the rotatable member 106 the reference marker 202 is detected. After the detection of the reference marker 202 by the sensor 204, the computing device 102 signals the motor to actuate the rotatable member 106 by specific angle so that the cavity shifts by the calibrated distance between the reference marker 202 and the cavity, and the cavity is aligned along the home position A, as illustrated in FIG. 2(a).

In another embodiment, the rough gemstone 108 and the gemstone holder 110 is mounted in the cavity, when the cavity is aligned along the home position A and the computing device 102 signals the motor to actuate the rotatable member 106. In an example, the magnet 206 in holds the gemstone holder 110 in the cavity during the actuation of the rotatable member 106.

As illustrated in FIG. 2(b), the actuation of the rotatable member 106 would be towards the detachment tool 114. Once, the rough gemstone 108 comes in contact with the detachment tool 114, the detachment tool 114 nudges the rough gemstone 108, such that the rough gemstone 108 detaches from the gemstone holder 110.

In an example, the detachment tool 114 may be configured to exhibit a motion with respect to the rotatable member 106 for at least a part of a path of rotation of the rotatable member 106. In another example, the motion exhibited by the detachment tool 114 may be a reciprocatory motion, or the like, such the motion of the detachment tool 114 allows the rough gemstone 108 to come in contact with the detachment tool 114 when the force generated by the magnetic field of the magnet 206 is marginally more than the external forces acting on the gemstone holder 110, thereby allowing seamless detachment of the rough gemstone 108 from the gemstone holder 110.

In an implementation, after the detachment, the rough gemstone 108 slides through the gemstone collecting bin 116 towards a collection unit attached at end of the gemstone collecting bin 116. In one example, the detachment tool 114 may have a guiding profile such that guiding profile may guide the detached gemstone into the gemstone collecting bin 116.

With the aforementioned features, the gemstone detachment assembly allows detachment and collection of the rough gemstones and their respective gemstone holders without human intervention. Specifically, in an example, the first portion of the path of rotation of the rotatable member 106 is the path which the gemstone holder 110 covers wherein the magnetic field of the magnet 206 holds the gemstone holder 110 in the cavity. At the end of the first portion of the path of rotation of the rotatable member 106, the detachment tool 114 comes in contact with the rough gemstone 108 to be detached held to the gemstone holder 110. Further, when the second portion of the path of rotation of the rotatable member 106 starts, the magnetic field may start weakening. In an example, at the end of the second portion of the path of rotation of the rotatable member 106, the gravitational force becomes greater than the force of the magnetic field by the magnet 206. Thus, the gemstone holder 110 unmounts from the cavity formed in the platform 112 of the rotatable member 106 under the action of gravity and falls into gemstone holder bin 118.

FIG. 2(c) illustrated that after the rough gemstone 108 gets detached, the rotatable member 106 again actuates to move the cavity towards the gemstone holder bin 118. In an example, the gemstone holder bin 118 may be located at 180 degrees from the home position A.

Upon alignment of the cavity along the gemstone holder bin 118, the gemstone holder 110 may dismount from the cavity and fall in the gemstone holder bin 118, as illustrated in FIG. 2(d). In an example, detached gemstone holders may be collected for reuse. In another example, detached gemstones may be collected for post-planning processing of rough gemstones.

The automated detachment mechanism elaborated in FIGS. 2(a)-2(d) is controlled by the computing device 102 with limited or no manual intervention and uses low-cost hardware equipment. Therefore, the gemstone detachment achieved in accordance with the techniques of the present subject matter provides a considerably accurate detachment of the rough gemstone and involves substantially low cost in generating the finished gemstone. In other words, the gemstone detachment executed in accordance with the present subject matter achieves increase in accuracy of detachment of the rough gemstone, the cost associated with the equipment, and energy efficiency of overall gemstone detachment mechanism.

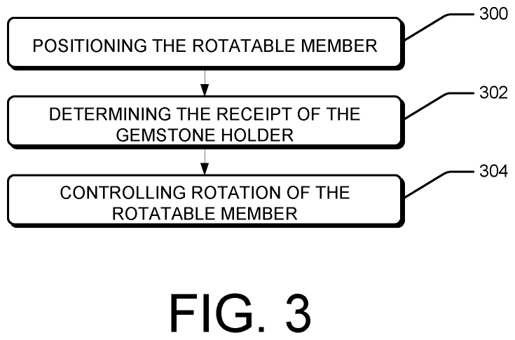

FIG. 3 illustrates the process of the detachment of the rough gemstone 108 from the gemstone holder 110 in accordance with the present subject matter. At block 300, the rotatable member 106 is aligned at the homing position by the computing device 102 with help of reference marker 202. Further, a pre-defined location is indicative of a location when the platform 112 is aligned parallel to the flat surface 120 of the gemstone detachment assembly 100. After mounting of the gemstone holder 110 the computing device 102 may communicate with the motor to actuate the rotatable member 106 by a pre-defined degree, amounting to alignment of the cavity perpendicular to the detachment tool 114. Once, the alignment is completed, a gemstone holder 110 wherein a rough gemstone 108 is attached, may be mounted in the cavity formed on the platform 112 of the rotatable member 106.

At block 302, when the gemstone holder 110 is mounted onto the rotatable member 106, the computing device 102 detects the gemstone holder 110 as received, based on the data received by the sensor 204. Furthermore, the gemstone detachment assembly 100 may include a magnet 206. The magnet 206 may have a hole at the centre. The gemstone holder 110 may be made up of magnetic material and the magnet may protect the gemstone holder 110 from dismounting from the cavity as a result of vibrations or the actuation of the rotatable member 106 or both. Further, the magnet is capable of generating a magnetic field to hold the gemstone holder when in a first portion of the path of rotation of the rotatable member and release the gemstone holder 110 in a second portion of the path of rotation of the rotatable member 106.

At block 304, the computing device 102 rotates the rotatable member 106 in a pre-defined direction. The gemstone holder 110 coupled to the rotatable member 106 moves towards the detachment tool 114. Once, the rough gemstone 108 comes in contact with the detachment tool 114, the detachment tool 114 nudges the rough gemstone 108, such that the rough gemstone 108 detaches from the gemstone holder 110. Further, the detachment tool 114 may be configured to exhibit a motion with respect to the rotatable member 106 for at least a part of a path of rotation of the rotatable member 106. Furthermore, the motion exhibited by the detachment tool 114 may be a reciprocatory motion, or the like, such the motion of the detachment tool 114 allows the rough gemstone 108 to come in contact with the detachment tool 114 when the force generated by the magnetic field of the magnet 206 is marginally more than the external forces, gravitational force, acting on the gemstone holder 110, thereby allowing seamless detachment of the rough gemstone 108 from the gemstone holder 110 after the detachment, the rough gemstone 108 slides through the gemstone collecting bin 116 towards a collection unit attached at end of the gemstone collecting bin 116. In one example, the detachment tool 114 may have a guiding profile such that guiding profile may guide the detached gemstone into the gemstone collecting bin 116. In addition, as described above, at the end of the second portion of the path of rotation of the rotatable member 106, the gravitational force becomes greater than the force of the magnetic field by the magnet 206. Thus, the gemstone holder 110 unmounts from the cavity formed in the platform 112 of the rotatable member 106 under the action of gravity and falls into gemstone holder bin 118.

Although implementations for gemstone detachment are described, it is to be understood that the present subject matter is not necessarily limited to the specific features of the systems or methods described herein. Rather, the specific features and methods are disclosed as implementations for gemstone detachment.

1. A gemstone detachment assembly comprising:
a rotatable member comprising a platform configured to receive and temporarily attach thereto a gemstone holder detachably holding a rough gemstone, wherein the gemstone holder is to exhibit a motion with the rotatable member for at least a part of a path of rotation of the rotatable member;
a detachment tool capable of being positioned in a path of the moving rough gemstone, wherein the detachment tool is configured to come in contact with the rough gemstone upon relative motion between the detachment tool and the rotatable member to detach the rough gemstone from the gemstone holder; and
a magnet positioned in proximity of the rotatable member to temporarily hold the received holder onto the platform, wherein the magnet is capable of generating a magnetic field to:
hold the holder when in a first portion of the path of rotation of the rotatable member; and
release the holder in a second portion of the path of rotation of the rotatable member.

2. The gemstone detachment assembly as claimed in claim 1, wherein the detachment tool is capable of moving in relation to the rotatable member.

3. The gemstone detachment assembly as claimed in claim 1, comprising a sensor fixedly disposed in proximity of the rotatable member to determine a homing position of the rotatable member, wherein the rotatable member comprises a reference mark for the sensor to determine the homing position thereof.

4. The gemstone detachment assembly as claimed in claim 1, wherein the detachment tool comprises a guiding profile to receive the detached gemstone, wherein the guiding profile is to guide the detached rough gemstone towards a gemstone collecting bin.

5. The gemstone detachment assembly as claimed in claim 1, wherein the magnet is disposed on a shaft of the rotatable member to be offset from a central axis of the shaft of the rotatable member.

6. A method for processing gemstones, the method comprising:
positioning a rotatable member at a homing position using a sensor disposed in proximity of the rotatable member;
determining, in the homing position of the rotatable member, a receipt of a gemstone holder detachably holding a rough gemstone, wherein the gemstone holder is temporarily attached to the rotatable member; and
controlling rotation of the rotatable member, wherein the gemstone holder is to exhibit a motion along with the rotatable member for at least a part of a path of rotation of the rotatable member such that the rough gemstone comes in contact with a detachment tool to be detached from the gemstone holder when in a first portion of the path of rotation of the rotatable member, and wherein the gemstone holder is to automatically detach from the rotatable member upon completing the first portion of the path of rotation of the rotatable member.

7. The method as claimed in claim 6, further comprising controlling motion of the detachment tool to move the detachment tool relative to the rotatable member.

8. The method for the detachment of the rough gemstone as claimed in claim 6, wherein the controlling the rotation of the rotatable member comprises rotating the rotatable member at a first speed until the gemstone holder is in proximity of the detachment tool and rotating the rotatable member at a second speed when the detachment tool is to detach the gemstone from the gemstone holder.

9. The method as claimed in claim 8, wherein the first speed is greater than the second speed.
